(19) United States
(12) Patent Application Publication
(10) Pub. No.: US 2004/0102206 A1
(43) Pub. Date: May 27, 2004

(54) Communication system

(76) Inventor: Peter Chambers, Ringwood (GB)

Correspondence Address: CROWELL & MORING LLP, INTELLECTUAL PROPERTY GROUP, P.O. BOX 14300, WASHINGTON, DC, 20044-4300, US

(21) Appl. No.: 10/362,830

(22) PCT Filed: Jul. 27, 2001
(86) PCT No.: PCT/EP01/08750

(30) Foreign Application Priority Data
Aug. 30, 2000 (GB) 0021166.4

(51) Int. Cl. H04B 7/00

(52) U.S. Cl. 455/522

(57) ABSTRACT

A communication system comprises a receiver; a transmitter; and a radio link. Information transmitted by the transmitter over the radio link is decoded in the receiver. The receiver comprises a pilot channel for using a transmitted pilot to assist in decoding operations; wherein the receiver generates a timing control signal of predetermined form; wherein operational conditions capable of degrading the predetermined form are determined by the receiver and wherein power of the transmitted pilot is modified such that the pilot tends to reduce the degradation of the timing control signal.

This invention relates to a communication system, and it relates especially, though not exclusively, to mobile telecommunications systems using Code Division Multiple Access (CDMA) coding.

Such systems typically use digital demodulation, and employ a so-called “pilot”, or reference, channel to properly align the demodulating operation with that of an incoming signal in a coherent manner in order to maximise the efficiency with which the demodulating operation is carried out, and thus optimise reception of the transmitted information.

The pilot channel can advantageously incorporate a so-called “Early-Late” delay lock loop, which operates by measuring the despread energy at “Early” and “Late” positions spaced ahead of and behind respectively a “Prompt” or correct timing position. In essence, when the timing is accurate, the energy levels measured early and late will be substantially equal and subtraction of one measured level from the other will give a nominal zero. On the other hand, if the timing is incorrect, one measured energy level will exceed the other, to an extent determined by the degree by which the signal is early or late, and the subtraction of one measured level from the other will thus give a positive or negative value of amplitude dependent on the extent of the timing error. It can thus be seen that the pilot channel generates, under ideal conditions, a classical “S”-shaped control signal which is used, in known manner, to adjust the timing of the demodulation.

Whilst the technique described above is suitable for use in many situations, it may be compromised in certain circumstances to some extent when used with a CDMA system using orthogonal codes. In these circumstances, the energy values measured at the “Early” and “Late” positions include components from the orthogonal codes which contaminate the desired signal to an extent which varies with timing, in a sense opposing, and thus tending to reduce, the amplitude of, the desired “S”-shaped control curve. Indeed, for mobiles close to a base station, operational conditions can easily arise in which the desired “S”-shaping of the control curve can be cancelled out, or even inverted.

This problem is addressed in our co-pending British Patent Application, Publication No. GB2349555, the specification of which is incorporated herein by reference, by means of a receiver modification whereby “Early” and “Late” samples of the incoming signal are measured against a locally generated signal comprising a code that is not included in the transmissions. That solution is effective, but only of course for receivers that contain the necessary modification.

This invention aims to address the same problem as that described above, but in a manner that does not require all receivers to be modified in the manner described and claimed in the aforesaid patent application.

WO99/12275 describes a communication system in which pilot channel transmit power is adjusted based on the speed of a remote unit. Such a system is concerned with the problem of degradation of radio links by speed. It does not deal with the problem of the present invention. Although it is a facility which could also be incorporated into a communication system using the present invention, the two are quite independent.

In accordance with the present invention, a communication system comprises a receiver; a transmitter; and a radio link; wherein information transmitted by the transmitter over the radio link is decoded in the receiver; wherein the receiver comprises a pilot channel for using a transmitted pilot to assist in decoding operations; wherein, in use, the receiver generates a timing control signal of predetermined form; wherein operational conditions capable of degrading the predetermined form are determined by pre-calculation at the transmitter; wherein pilot and bearer physical channel power levels are monitored to determine the operational conditions and a so-called “stability equation” or formula is used to predict whether the pilot power is sufficient to permit the generation of the timing control signal of said the predetermined form; and wherein the power of the transmitted pilot is modified such that the pilot tends to reduce the degradation of the timing control signal.

The present invention modifies the power of the pilot transmission to correct errors in the timing control signal, introduced by operational conditions. By determining the operational conditions capable of degrading the predetermined form at the transmitter, no feedback, which tends to be error-prone, is involved and no modifications to the users equipment are required. The technique also allows the total power at the base station to be controlled. The system can predict from theory whether the pilot signal power is likely to be sufficient to generate a timing control signal of acceptable form to correctly decode a received transmission.

It is preferred that the timing control signal conforms to an “S” shaped curve. Such curves are capable of accurate interpretation, even by relatively inexpensive circuits.

Still further it is preferred that the timing control signal is derived by respective “Early” and “Late” sampling of the pilot signal, and comparison of the samples, for example by subtraction. This conforms to standard and well proven practice.

The system preferably further comprises thresholding to avoid continuous adjustments of the pilot power in response to relatively minor changes in the operational conditions. This ensures that continuous minor adjustments of the pilot power are not incorrectly interpreted by the receiver as information of significance.

Preferably, the radio link comprises a CDMA radio link.

In order that the invention may be clearly understood and readily carried into effect, one embodiment thereof will now be described, by way of example only, with reference to the accompanying drawing in which:

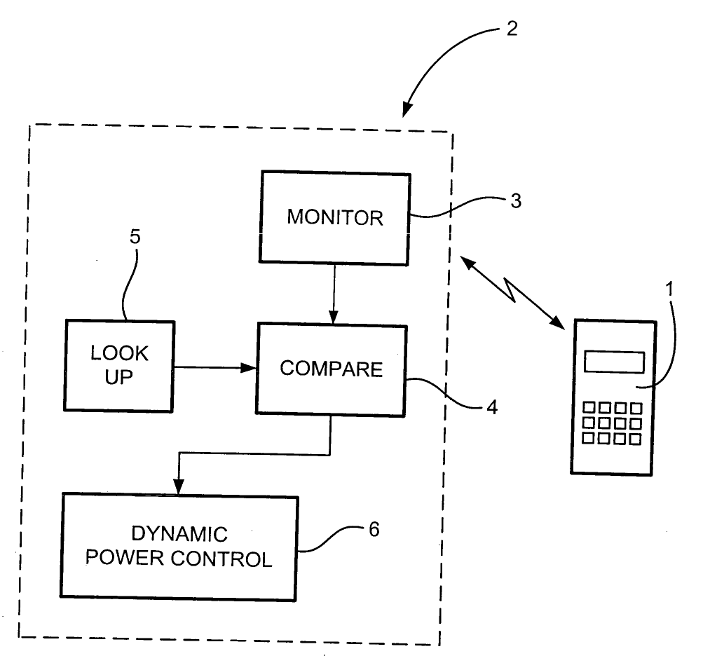

FIG. 1 shows in block diagrammatic form one embodiment of a communication system in accordance with the invention.

Referring now to FIG. 1, a mobile receiver 1 of a communication system operating via CDMA radio link is sited close to a base station 2.

The base station 2 incorporates a monitor 3 the function of which is to monitor the respective powers in pilot and information (bearer) channels and a comparison circuit 4 whose function is to compare monitored values of pilot and bearer channel power with datum information derived from a look-up table 5 of operational criteria in the form of formulae, such as stability equations, in order to determine whether the performance of the pilot channel in the receiver 1 is likely to be degraded as a result of the phenomenon described above.

The base station 2 further incorporates a dynamic power control circuit 6 by means of which the power of a pilot can be adjusted. This control circuit 6 is configured to receive output signals from the comparison circuit 4 and to respond to those output signals by adjusting the power of the pilot accordingly.

It is preferred that the comparison circuit 4 incorporates a threshold component which suppresses the generation of output signals from the circuit 4 unless the comparison indicates that a significant adjustment of the pilot power is required. This prevents the pilot power being continuously subjected to minor adjustments, which could introduce other errors. Once the threshold is exceeded, the pilot power may be adjusted continuously, or it may alternatively be subject to a secondary threshold to ensure that control is increased in discrete steps. In any event, there will of course be a maximum level beyond which the pilot power cannot be increased.

Thus the invention aims to ensure that pilot power is sufficient to resist degradation of the “S”-shaped control curve by dynamically adjusting it to exceed a normally required base power level. Hence, the pilot power is boosted only when needed to ensure stability of reception of (pseudo-) orthogonal channels in a CDMA radio link.

Although the invention has been described with respect to a particular embodiment, it will be appreciated that its scope is not intended to be limited thereto, and that those skilled in the art will envisage various applications of the inventive principle that may well differ significantly in form and implementation from the specific embodiment described herein.

1. A communication system, the system comprising a receiver; a transmitter; and a radio link; wherein information transmitted by the transmitter over the radio link is decoded in the receiver; wherein the receiver comprises a pilot channel for using a transmitted pilot to assist in decoding operations; wherein, in use, the receiver generates a timing control signal of predetermined form; wherein operational conditions capable of degrading the predetermined form are determined by pre-calculation at the transmitter and wherein power of the transmitted pilot is modified such that the pilot tends to reduce the degradation of the timing control signal.

2. A system according to claim 1, wherein the pilot and bearer physical channel power levels are monitored to determine the operational conditions and a so-called “stability equation” or formula is used to predict whether the pilot power is sufficient to permit the generation of the timing control signal of the predetermined form.

3. A system according to claim 1 or claim 2, wherein the timing control signal conforms to an “S” shaped curve.

4. A system according to any preceding claim, wherein the timing control signal is derived by respective “Early” and “Late” sampling of the pilot, and comparison of the samples, for example by subtraction.

5. A system according to any preceding claim further comprising thresholding to avoid continuous adjustments of the pilot power in response to relatively minor changes in the operational conditions.

6. A system according to any preceding claim wherein the radio link comprises a CDMA radio link.
